(19) United States
(12) Patent Application Publication
(10) Pub. No.: US 2024/0095151 A1
(43) Pub. Date: Mar. 21, 2024

(54) OPTIMIZED TEST SELECTION

(71) Applicant: GM Cruise Holdings LLC, San Francisco, CA (US)

(72) Inventors: Aravindha Ganesh Ramakrishnan, Santa Clara, CA (US); Wei Sun, Fremont, CA (US); Ritchie Lee, Sunnyvale, CA (US); Ishan Singh, San Francisco, CA (US); Saurabh Gupta, San Carlos, CA (US); Brooke Colburn, Spokane, WA (US)

(21) Appl. No.: 17/945,829

(22) Filed: Sep. 15, 2022

(51) Int. Cl. G06F 11/36

(52) U.S. Cl. CPC G06F 11/3676; G06F 11/3692

(57) ABSTRACT

Aspects of the disclosed technology provide solutions for identifying autonomous vehicle (AV) tests that provide a desired level of test coverage for testing or validating the AV software stack. A process of the disclosed technology can include steps for extracting a first set of features associated with a first set of test programs, tagging each respective test program with metadata tags, and identifying a second set of features associated with an updated set of AV program code. In some aspects, the process may further include steps for determining if the one or more tags match one or more features of the second set of features associated with the updated AV program code, and executing the respective test programs based on the one or more tags. Systems and machine-readable media are also provided.

### BACKGROUND

### 1. Technical Field

The present disclosure is generally directed to improving operation of autonomous vehicles. More specifically the present disclosure is directed to identifying tests that can be used to validate operations implement by autonomous vehicle (AV) software.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may include the collection and processing of large quantities of data using various sensor types, including but not limited to cameras, Light Detection and Ranging (LiDAR) sensors, and Radio Detection and Ranging (RADAR) disposed on the AV, among other sensor types.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a process of adding identifiers, that may be referred to as “tags”, to test programs that may be used to identify test programs that should be executed after particular sets of program code have been updated on an autonomous vehicle (AV), in accordance with some examples of the present disclosure.

FIG. 2 illustrates a series of operations that may be performed to identify test programs that are relevant to a particular autonomous vehicle (AV) program code stack change or update, in accordance with some examples of the present disclosure.

FIG. 3 illustrates operations that may be performed when test programs that are relevant to a particular road event are identified, in accordance with some examples of the present disclosure.

FIG. 4 illustrates a set of operations that may be performed when relevant test programs are executed, in accordance with some examples of the present disclosure.

FIG. 5 illustrates a set of operations that may be performed when relevant test programs are selected for execution, in accordance with some examples of the present disclosure.

FIG. 6 illustrates an example computing system that may be used to implement at various AV test maintenance operations, in accordance with some examples of the present disclosure.

FIG. 7 illustrates an example of an autonomous vehicle environment, in accordance with some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Described herein are systems, apparatuses, processes (also referred to as methods), and computer-readable media (collectively referred to as “systems and techniques”) for optimizing test coverage for software tests that are used to test software of autonomous vehicles (AVs). Software implemented by AVs can change rapidly, and changes made to certain portions of code can affect other portions of code, resulting in errors and other problems in the code. For example, when changes are made to a set of program code, the changes can cause side effects or errors to various other aspects of the AV software stack. In many cases, the side effects associated with a given update can be unpredictable. Because of the unpredictable consequences of such changes, tests (or AV tests) can be used to validate AV software performance after the update.

In a development environment, changes to program code occur rapidly and side effects associated with those change are often unpredictable; thus it may be difficult to know which AV tests are the most important or may be the most useful in revealing those unpredicted side effects. In certain instances, hundreds or even thousands of test programs may have already been developed and these existing test programs may have been written by numerous different engineers. This means that individual engineers and an entire organization that develop test programs have no clear understanding of whether a test exists that is sufficient to test a new AV program code update or whether new tests need to be developed. As a result, test engineers or their management may opt to develop a new test program instead of using existing test programs.

Aspects of the disclosed technology provide solutions for identifying the relevance of variously existing tests with respect to updates performed on an AV software stack. The systems and techniques described herein can allow engineers to rapidly identify relevant tests from a larger set, such as those that can provide a threshold level of desired test coverage. In some aspects, test coverage may be determined by identifying features associated with certain portions of AV program code and identifying test programs that test those features. Each of the features may be stored in a storage, such as a database, that cross-references/maps these features with specific events that have been or that may be encountered as autonomous vehicles drive along a roadway. Furthermore, each of these events and/or features may be cross-referenced with a driving topic. This cross-referenced/mapped data may be used to identify tests that should be run. Collected data may be used to identify test coverage metrics such that a level of test coverage can be estimated before a set of tests are executed.

Levels of test coverage may be measured using metrics that are collected when a suite of test programs that test the operation of an updated program code set are run. These metrics may relate to a number of instructions executed, numbers of code paths traced, and/or numbers of subroutines called when instructions of an updated program code set are tested, etc. From these metrics, calculations may be performed to identify a level of test coverage provided by running the suite of test programs. Such methods may identify features associated with certain portions of program code and may identify test programs that test those features. Each of the features may be stored in a database that cross-references/maps these features with specific events that have been or that may be encountered as autonomous vehicles drive along a roadway. Furthermore, each of these events and/or features may be cross-referenced with a driving topic. This cross-referenced/mapped data may be used to identify tests that should be run. Collected data may be used to identify test coverage metrics such that a level of test coverage can be estimated before a set of tests are executed.

In certain instances, groups of instructions that are included in an updated program code set may be included in a set of metrics. For example, a particular subroutine may include 100 instructions, of which 40 of those instructions are executed when a first set of test programs are run. A second set of test programs may then be selected and run on the updated set of program code. The running of the second set of test programs may identify a second grouping of instructions executed after the running of the first and the second set of test programs are run. The running of the second set of test programs may increase the number of instructions of this subroutine that are run to 90 out of the 100 instructions. A rule that identifies required test thresholds may identify that 90% of instructions of this subroutine must be executed to meet the required test coverage threshold.

After a suite of test programs are executed and metrics are collected, the level of test coverage may be calculated as a percentage. Such percentages may be compared to a total number of instructions included in the set of updated program code with the number of instructions executed when the suite of test programs was executed. Similar percentages may be calculated using total numbers of code paths or numbers of subroutines included in the set of program code with the number of code paths traced or the number of subroutines called.

A rule that identifies a threshold level of test coverage may require that 85% of all instructions of an updated program code set be executed when a suite of test programs is run. Such a rule may also require that 90% of code paths included in the updated code set be traversed. Additionally, or alternatively such a test coverage threshold level rule may require that 85% of subroutines that are associated with the updated program code be accessed. These percentages are provided as examples and such percentages may be set at any value based on preferences of a development organization.

Various items may be identified or used when developing processes for optimizing test coverage of a set of tests (e.g., a suite of tests or test suite). Because of this, the systems and techniques described herein can be used to identify features that a particular program code change affects or may affect. In some examples, the systems and techniques described herein can identify metrics that quantify an amount of program code that a certain set of tests covers. The systems and techniques described herein can be used to intelligently identify tests that provide a certain/desired test coverage and can allow for efficient and selective testing of AV software. As a result, the systems and techniques described herein can provide more efficient and targeted testing of AV software than alternatively performing costly and inefficient end-to-end tests of the AV software of an autonomous vehicle.

In some cases, the systems and techniques described herein can be used to identify a minimal amount of testing (or fewest number of AV tests) that provides a maximum or threshold level of test coverage. The process for identifying a minimal amount of testing can include accessing data that has been collected by computers of one or more AVs. The collected data may be referred to herein as AV bag data or road bag data. The data may be used to cross-reference events that have occurred along roadways with features that are associated with those events. Example events can include, but are not limited to, stop light events, stop sign events, hard braking events, loss of traction events, unprotected left turn events, highway driving events, close (e.g., within a threshold) encounter events, impaired visibility events, and congested roadway events, among others.

Additional classifications of datasets that the systems and techniques described herein can include are “features” and “topics.” A feature can include an operation performed by an AV and/or an event associated with the AV. A feature can be a sub-event or can be more granular than an event associated with a feature. For example, an event can include a boundary change, and an associated feature can include a lane change or leaving the roadway. In other words, a feature associated with an event can further describe the event and/or an activity associated with the event, and/or can provide a more granular representation of the event, an activity associated with the event, and/or a type or classification of the event. Moreover, a topic can be more granular than a feature associated with an event. For example, a topic can provide, describe, and/or represent a context associated with a feature and/or additional details associated with a feature.

In some examples, a particular topic or set of topics may be associated with one or more events and/or one or more features. In certain instances, a topic may be synonymous with an event or a topic may include one or more events. In other instances, multiple topics may be associated with an event. While a feature may be synonymous with an event or an event may include one or more features, features may be data that is more granular than information used to define an event.

An event may identify one or more conditions associated with an AV, an event associated with an AV, an activity and/or operation associated with an AV, a context associated with an AV, and/or one or more features or topics associated with an AV, among other things. For example, an event may identify that an AV has left a boundary of the roadway. Different events that may be associated with the AV leaving a boundary may include, for example and without limitation, changing into a lane, changing lanes into a lane traveling in an opposite direction, smooth boundary change motion (e.g., boundary change motion below a threshold), hard/jerky boundary change motion (e.g., boundary change motion above a threshold), leaving a highway lane when exiting the highway, leaving a lane when moving onto a shoulder of the roadway, and entering an intersection, among others. Thus, a feature associated with an event can be more granular than the event (e.g., can provide further details and/or context associated with the event), and a topic associated with a feature can be more granular than the feature (e.g., can provide further details and/or context associated with the event). Furthermore, a topic may be more granular than a feature.

Additional classifications of datasets that the systems and techniques described herein can include are “features” and “topics.” A feature can include an operation performed by an AV and/or an event associated with the AV. A feature can be a sub-event or can be more granular than an event associated with a feature. For example, an event can include a boundary change, and an associated feature can include a lane change or leaving the roadway. In other words, a feature associated with an event can further describe the event and/or an activity associated with the event, and/or can provide a more granular representation of the event, an activity associated with the event, and/or a type or classification of the event. Moreover, a topic can be more granular than a feature associated with an event. For example, a topic can provide, describe, and/or represent a context associated with a feature and/or additional details associated with a feature.

In some examples, an event can include an AV has left a boundary (a first event) by changing lanes of a roadway. Details relating to how the lane change was performed or why the lane change was performed may be topics about the lane change. A mapping of topics to events and/or features may include, for example and without limitation, a boundary change mapped to a lane change event, a lane change event mapped to a smooth boundary change, among others. Table 1 (shown below) includes different example topics that are cross-referenced with example events and features. The topics, events, and features in Table 1 are merely illustrative examples provided for explanation purposes. Other examples are contemplated herein. Table 1 includes different events that are cross-referenced with possible features and topics. In some instances, an event of boundary change maps to lane change features and leaving roadway topics. The topics associated with the lane change features may be cross-referenced with different types of topics.

Program code that associates specific events to features (e.g., that associates an event, topic, and feature with each other) and topics may assign Boolean operators to specific topics. For example, the first event entry of a boundary change in Table 1 maps to a lane change feature that is smooth (e.g., that involves an amount of motion below a threshold level) and that may also be associated with one or more topics such as, for example, of passing, lane ending, same direction of travel, and/or different direction of travel. In this example, features of passing, lane ending, same direction of travel, and different direction may be assigned Boolean operators with a true or false (e.g., 1 or 0) state that identify whether the specific topics are pertinent to a specific lane change feature. Such Boolean operators may identify that the feature is or includes passing in the same direction of travel and that the feature is not associated with a lane ending or different direction of travel topic (e.g., using an AND function of Boolean states). Entries of Table 1 may be used to identify topics using an assumed OR function. In such instances, any lane change event that involves one or more of a group of mapped topics may be used to identify tests that should be performed on a set of program code.

In some instances, the event of boundary change can be mapped with the features smooth lane change and hard turn feature. A hard turn may be associated with a non-linear or angular acceleration (possible above predefined threshold values). Here again topics included in Table 1 may be associated with Boolean operators. In this example, the event of boundary change may be associated with a feature of leaving roadway that may be mapped to one or more topics of highway exit, onto shoulder, protected turn, and/or unprotected turn. Another mapping of Table 1 includes an event of following boundary change associated with a feature speed change, which in turn may be associated with one or more topics that indicate an increase in speed or a decrease in speed of the vehicle. As shown in Table 1, topics, events, and features can be interrelated, and mapped to each other based on a relationship between them. Moreover, a feature associated with an event is more granular than the event, and a topic associated with that event is less granular than the event and the feature associated with the event.

TABLE 1
Event, Feature, Topic Mapping Example 1

| Event | Feature | Topic |
|---|---|---|
| Boundary Change | Smooth Lane | Smooth Turn |
| | Change | |
| | | Passing |
| | | Lane Ending |
| | | Same direction |
| | | of travel |
| | | Different |
| | | direction of |
| | | travel |
| Boundary Change | Hard Lane | Hard Turn |
| | Change | |
| | | Obstacle |
| | | Lane Closed |
| | | Same direction |
| | | of travel |
| | | Different |
| | | direction of |
| | | travel |
| Boundary Change | Leaving | Highway exit |
| | Roadway | |
| | | Drive onto |
| | | shoulder |
| | | Protected Turn |
| | | Unprotected |
| | | Turn |
| Following | Speed | Increase in |
| Boundary Change | Change by | Speed |
| | Threshold | |
| | Level | |
| | | Decrease in |
| | | Speed |
| Threshold Level | Hard | Reduced Speed |
| Speed Change | Braking | Limit |
| | Feature | |
| | | Obstacle |
| | | Type of |
| | | Obstacle |
| Threshold Level | Threshold | Passing |
| Speed Change | Acceleration | |
| | | Other |

Table 1 also includes events of threshold level speed change that may be associated with a reduced speed limit or an acceleration feature. Here again, each of these different features may be mapped to different topics as shown in Table 1. A topic can be mapped to different events in some cases, and an event can be mapped to different features in some cases.

TABLE 2
Event, Feature, Topic Mapping Example 2

| Event | Feature | Topic |
|---|---|---|
| Yellow Light | While | Maintain |
| | Entering | Speed |
| | Intersection | |
| Yellow Light | Normal | Before Entering |
| | Braking | Intersection |
| Yellow Light | Hard | Before Entering |
| | Braking | Intersection |
| All Way Stop | Sequence | Proceed |
| | of Stop | According to |
| | | Sequence |
| All Way Stop | Driver | Yield to |
| | Asserting | Asserting |
| | Right of | Driver |
| | Way | |
| | | No Yield to |
| | | Asserting |
| | | Driver |

Table 2 illustrates another example of mappings of topics, events, and features (e.g., events mapped to features that are mapped to topics). The example mappings of events to features and topics can be used to identify tests to execute/perform on specific software code, such as an updated software code set. For example, initially, a feature associated with updated software code and a test program feature (e.g., a feature of a software test program) can be identified. Any test program that shares a feature in common with the feature of the updated software code can also be identified. One or more test programs can then be added to a suite of test to run on the updated set of program code. This can include associating matching features (e.g., features in common between a test program and updated software code) with topics. Additional tests can be identified based on the association between the matching features and the topics. In some examples, additional features that are mapped to a topic can further be identified and executed. Thus, the testing can start narrow with a smaller number of tests that is based on the feature mappings (e.g., a smaller number of tests can be identified based on feature mappings and subsequently executed). Testing can then be expanded by identifying an event mapped to the feature initially tested. For example, a test corresponding to an event mapped to the feature can be identified and executed to broaden the scope of the test relative to the scope of the test corresponding to the feature. A larger test set can further be identified based on a topic mapped to the feature and event previously identified and/or tested.

In some cases, test coverage metrics can be used to identify when the testing is done. In some examples, a threshold can be used to determine when testing is done. For example, a threshold level of testing used to determine when testing is complete can be based on a certain percentage of instructions in the updated software code being tested. To illustrate, when 90% of the instructions in the updated software code are tested, the testing can be determined to be complete. Here, 90% of the instructions in the updated software code can be used as the threshold level for determining testing completion.

In one illustrative example from Table 2 includes events, to feature, to topic mappings that may be used to identify tests that should be executed on a set of program code. Events of Table 2 include mappings that maps event yellow light to a “while entering intersection” feature, and to a topic of “maintain speed.” The feature of “while entering intersection” may be associated with a time until the vehicle will enter the intersection. When a light turns yellow, the AV will have a limited amount of time to move through the intersection before the light turns red. Because of this, the feature “while entering intersection” may be associated with a point that is located before the actual place where the intersection begins. In an additional illustrative example from Table 2, a yellow light event is mapped to various events including a normal braking feature (e.g., braking involving a deceleration amount within a range of deceleration levels) and a hard braking feature (e.g., braking involving deceleration by a threshold amount or more), and both events are mapped to the topic of “before entering intersection.” In some examples, a narrower test for a feature in Table 2 can be used to identify and execute a test of updated software code. The event(s) and/or topic(s) associated with such feature can be used to expand the testing to include a broader scope defined or described by the event(s) and/or topic(s) associated with the feature.

Table 2 also includes the event of “all way stop” that is mapped to one or more topics of proceed according to a sequence required by law. For example, topics may include proceeding based on first to stop and first to go convention or follow standard all way stop right of way rules. Other mappings may identify instances when “all way stop” event maps to a feature “driver asserting right of way” which in turn could map to topics of “yield to asserting driver” or “do not yield to asserting driver.”

The term “topic” may refer to or have a correspondence to a low-level software construct, which may be referred to as a Robot Operating System Topic (ROS topic). Each software component of an AV may have a set of topics that are of interest to other software components of the AV and each AV or other source may periodically publish updates to these topics. Other components of an AV system subscribe to topics that are of interest to them (e.g., subscribing to a newsfeed) and consume the updates to these topics. Such a subscription model may include configuring computers of a group of AVs to share or publish data to computers of a company/entity that developed hardware or software deployed on the group of AVs. Here a test administration computer may be configured as a subscriber that receives data from the computers that publish that data. This process may include a computer of an AV collecting and storing sets of data that may be referred to as “bag” data or “road event” data. In an instance when an AV computer identifies that the AV has experienced a hard braking action, bag data associated with times before, during, and after that hard braking action may be sent to a subscribing computer. The subscribing computer may evaluate this shared bag data to identify features associated with a topic of the hard braking event.

In terms of granularity: topics may be more granular than features which in turn may be more granular than the event. As an example, if an event is—the AV did not change lanes when it should have, multiple features can be used to describe this topic. One of these features could be “lane change information”. This feature in turn may rely on multiple topics such as “diagnostics_AV_intent status” and “lane_change status.” “

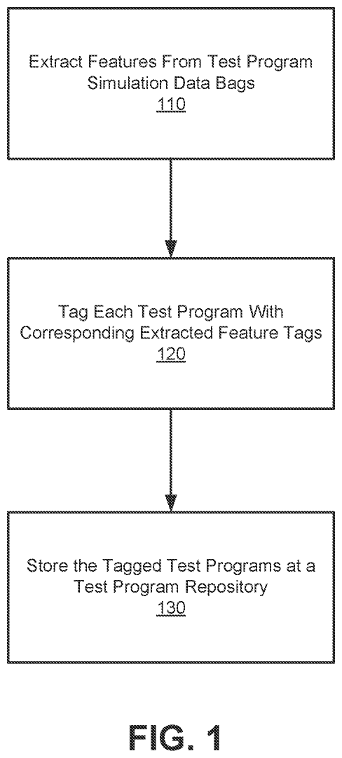

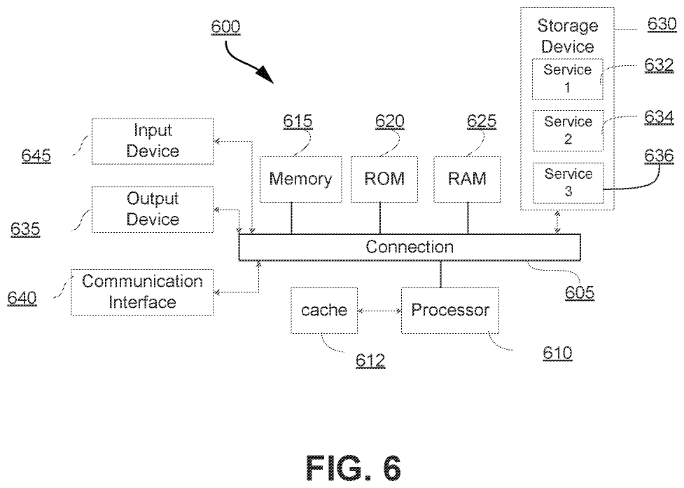

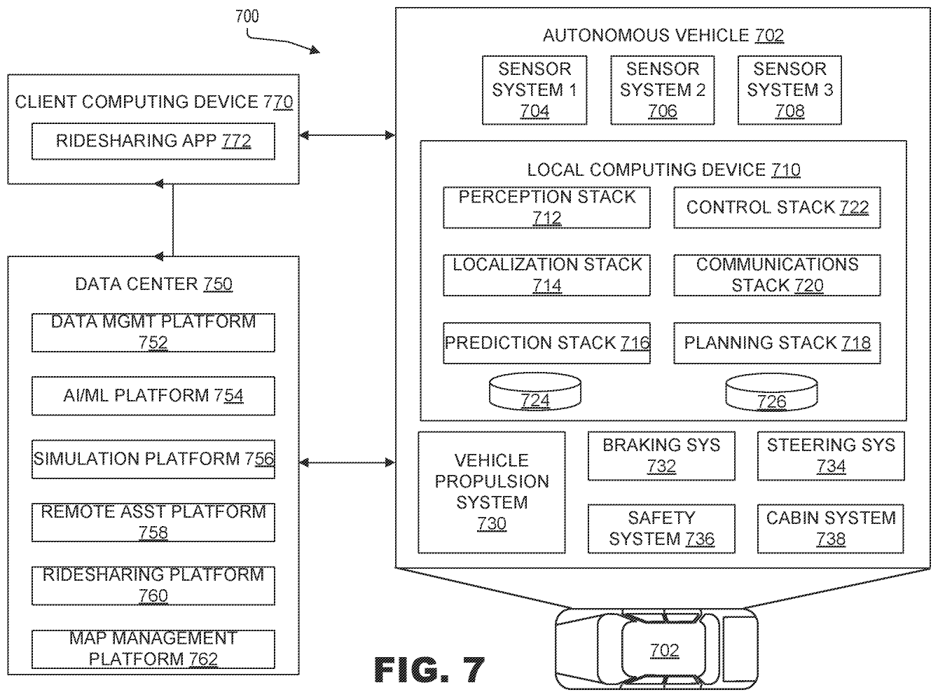

FIG. 1 illustrates a process of adding identifiers, which may be referred to as “tags”, to test programs, which may be used to identify test program characteristics, e.g., to facilitate the selection of tests that should be executed after particular code update. The operations of FIG. 1 may be implemented to identify test programs that should be executed on a particular set of updated program code. Such test programs may be executed by a computer system such as the computing device illustrated in FIG. 6 when testing AV software that may run on a computer of the AV of FIG. 7. When a test program is used to test specific sets of AV program code, data associated with the operation of the AV may be collected and stored in sets of simulation bag data. In such instances, a first test program may command an AV control system to execute a passing operation. At this time, the test program and AV program code sets may both be executed as part of a computer simulation and data associated with that simulation may be collected and stored as a set of simulation bag data. Evaluations performed on this stored bag data may be used to extract features from test program simulation data. These evaluations may identify that the stored data is associated with the feature of “threshold level of acceleration” and the test program may be tagged or annotated with data that identifies the threshold level of acceleration. Operation 110 of FIG. 1 may include extracting or identifying features to associate with the test program simulation bag data. In some examples, a local computing device (e.g., local computing device shown in FIG. 7) associated with the AV may extract or identify features to associate with the test program simulation bag data.

In some cases, a local computing device (e.g., local computing device 600 shown in FIG. 6) of the AV can analyze the updated AV stack to determine features associated with the updated AV stack. For example, if the updated AV stack is configured to control lane changes and entering/exiting a roadway, the features of the updated AV stack can include a particular speed or range of speeds maintained during lane changes and an amount of acceleration/deceleration implemented when entering/exiting a roadway.

In some cases, the features may be identified based on input provided by a user, such as a developer, that updated the AV stack (e.g., the set of program code associated with the AV stack). For example, the features may be provided by the user (e.g., a developer, etc.) via a user interface that allows the user to provide descriptors and/or queries that identify those features. In instances where the user does not know the set of features that are associated with the updated AV stack, the user may send descriptors and/or queries to a code test database that stores information that cross-references program code sets to features. The descriptors and/or queries can be used to identify the features within the code test database.

In operation 120, the test programs (such as the acceleration test discussed above) may be tagged with the names of any extracted features. Next, in operation 130, the tagged test program may be stored in a test repository. At this point, the repository is ready to be queried to identify tests based on the tags. Once associations are formed that cross-reference specific test programs with specific features, any set of program code that is updated and that also is associated with those specific features may be tested with test programs that have tags that match any of those specific features. The set of test program features can include features that a test programs is configured to test. For example, a test program can include a software program configured to test one or more AV stacks (and/or portions thereof) or, more specifically, configured to test a set of features such as the set of test program features identified by operation 120. Thus, if the set of test program features that a test program is configured to test matches the features of the updated AV stack identified by operation 110, then the test program can be used to test the updated AV stack given that the test program is configured to test the features of the updated AV stack (e.g., as determined based on a match between the features of the updated AV stack and the set of test program features associated with the test program).

For example, if the updated AV stack controls a set of functions/capabilities such as lane changes and entering/exiting a roadway and the features identified at operation 110 (e.g., the features of the updated AV stack) include a particular speed or range of speeds maintained during lane changes and an amount of acceleration/deceleration implemented when entering/exiting a roadway, the process 110 can determine a match between the features of the updated AV stack (e.g., the features identified at operation 110) and the set of test program features (e.g., the features identified at operation 120). Such a match between the features of the updated AV stack and the features of the test program can be used to identify/select test programs that can be executed to test the updated AV stack. For example, such a match can be used to identify and/or select a test program configured to test lane changes and entering/exiting a roadway and, more specifically, to test that the updated AV stack can maintain a particular speed or range of speeds during lane changes and implement an amount of acceleration/deceleration when entering/exiting a roadway.

As another example, if the updated AV stack controls an operation of the AV when the AV encounters a yellow light and the features identified at operation 110 (e.g., the features of the updated AV stack) include a particular amount of braking (e.g., a threshold amount or threshold ranges of deceleration when encountering a yellow light), the process 110 can determine a match between the features of the updated AV stack (e.g., the features identified at operation 110) and the set of test program features (e.g., the features identified at operation 120). Such a match between the features of the updated AV stack and the features of the test program can be used to identify/select a test program that can be executed to test the updated AV stack. In this example, such a match can be used to identify and/or select a test program configured to test braking when encountering a yellow light and, more specifically, to test that the updated AV stack can implement a certain amount of braking (e.g., a threshold amount of deceleration without exceeding a maximum deceleration threshold with assurance that the braking exceeds a minimum deceleration threshold) when encountering a yellow light.

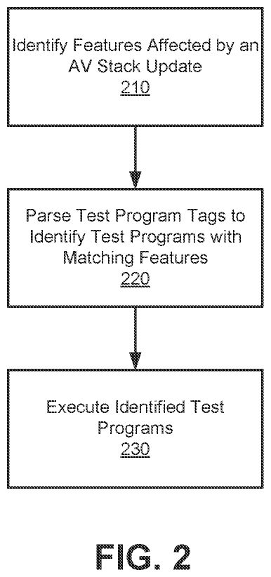

FIG. 2 illustrates a series of operations that may be performed to identify test programs that are relevant to a particular autonomous vehicle (AV) program code stack change or update. FIG. 2 begins with operation 210 where features affected by the AV program code stack change are identified. Operation 210 may be implemented based on inputs provided by an engineer that made a program code change. For example, user inputs may be received via a user interface, such as a graphical user interface (GUI) or a command line interface. This may include selecting features from a list or by a developer typing text into a user interface. In instances where the engineer knows what features are impacted by their code change, that engineer may provide input (e.g. GUI selections or text) that identifies these known features.

In other instances, a test program optimization system may automatically identify features associated with a particular set of updated program code. For example, a computer may compare different revisions of AV stack program code to identify which program code modules have changed or the engineer may provide input that identifies the changed program code modules. Once the test program optimization system receives information that identifies the code changes, that system may identify features that may be affected by the changed program code based on identified topics or events associated with the changed program code modules. For example, when updates to a set of program code are known to be associated with the event of a boundary change (e.g. changing a lane or exiting a roadway), that set of program code may be associated with features of “smooth lane change,” “hard lane change,” or “leaving roadway” as discussed in respect to Table 1. Similarly, program code sets are known to be associated with the event of a yellow light, those program code sets may be associated with features of “while entering intersection,” “normal braking,” or “hard braking” as discussed in respect to Table 2. While not illustrated in FIG. 2, data may be stored that cross-references specific program code sets with one or more features.

Next in operation 220, the features identified in operation 210, or names associated with those features, may be used to search a test repository for test programs that are tagged with tags that map to the features or feature names. For example, test programs that are tagged with the feature of “hard lane change” may be selected for execution when an updated program code set is also associated with the feature of “hard lane change.” Other examples of matching features include any of the features illustrated in Table 1 or Table 2. Here again, features identified by test program tags that match features that have been associated with an updated program code set may be selected for execution based on feature mapping. This may include parsing all programs that were stored in the test repository in operation 130 of FIG. 1 to identify test programs that have been tagged with a matching feature tag. This search may identify a set of test programs that contain the features that are relevant to the AV program code stack update. After operation 220, these relevant test programs can be executed on the AV program code stack in operation 230.

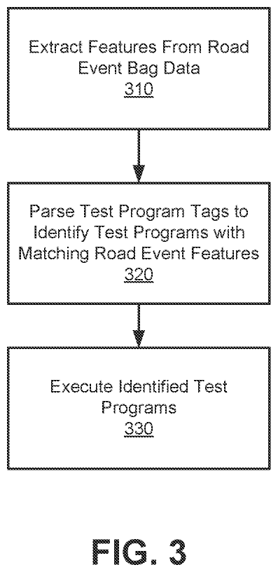

FIG. 3 illustrates operations that may be performed when test programs that are relevant to a particular road event are identified. As discussed above, boundary changes, threshold levels of speed changes, a yellow traffic light, and an all-way stop are examples of road events that may be represented in bag data collected through operation of an AV. This bag data may have been received from an AV as or after that AV encountered one of these events. The bag data may be evaluated when features associated with a particular event are identified in operation 310. This may include identifying that a boundary change event corresponds to a feature of leaving a roadway and may also include identifying features associated with data associated with times before, during, and after the occurrence of the event. For example, the boundary change event may be linked to the leaving roadway feature and to features of speed change by a threshold level after the boundary change event.

Before any updated AV software is put into production, it is important to run tests related to previous road events to ensure that any anomalous actions previously performed by the AV will not reoccur. After features associated with the road event are identified/extracted in operation 310, the test repository may be searched in operation 320. This may include parsing test program tags to identify test programs that are associated with matching road event features. Any test program that has been tagged with a tag that matches a feature tag or name may be classified as a relevant test and a set of all relevant tests may then be executed in operation 330 of FIG. 3. The purpose of the operations of FIG. 3 is to provide information about the ability of an AV control system to perform well in scenarios similar to the road event of operation 310.

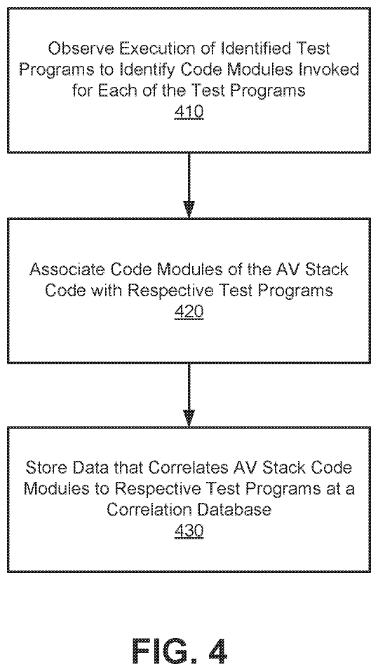

FIG. 4 illustrates a set of operations that may be performed when relevant test programs are executed. When a test program is executed on a set of AV program code, operations performed based on the execution of that AV program code may be observed by a processor executing a set of observation code (i.e., an observation program or module). The execution of such a set of observation code may act in a manner similar to a computer emulator that tracks instructions executed by a processor. Data associated with actual road events may be used in a computer simulation when actions performed by a virtual AV are observed. In operation 410, the processor executing the instruction of the set of observation code may identify particular program code modules that are invoked when each of a set of test programs are executed. Next in operation 420, each program code module of an AV code stack may be associated with respective test programs. For example, in an instance when the program code module being tested corresponds to a braking profile, that code module may be associated with a set of test programs that are tagged with features associated with braking events. After the associations are created between the AV software code modules and the test programs in operation 420, data that correlates the AV program code stack modules to the respective tests may be stored at a correlation database in operation 430.

In the future, whenever an update is made to a particular AV program code module, tests that are correlated to that AV program code module may be identified by parsing the data stored in operation 430. Any test programs that are correlated to the updated AV program code module may then be executed by computers of an AV test system based on that correlation.

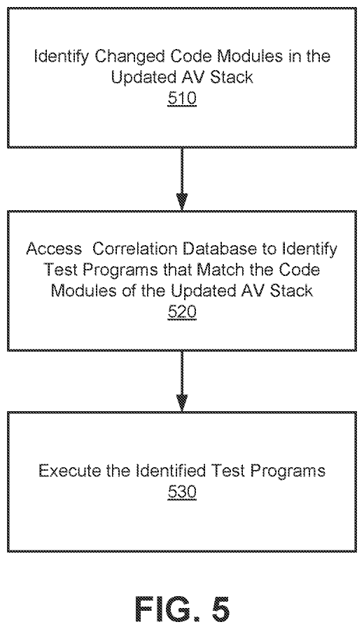

FIG. 5 illustrates a set of operations that may be performed when relevant test programs are selected for execution. Program code modules that have been changed in an updated set of AV program code may be identified in operation 510 of FIG. 5. The identifications performed in operation 510 may be based on user input that identifies features associated with a code change or that identifies program code modules that have changed. As mentioned above, an engineer that makes a code change may identify feature information that identifies software modules that have changed. Alternatively, or additionally, the features or program code modules identified in operation 510 may have been identified based on a set of program code that compares content of different sets of program code or that identifies features associated with program code modules that have changed.

Next, in operation 520, a code correlation database may be accessed. This code correlation database may be the same code correlation database discussed in respect to FIG. 4. The data accessed in operation 520 may be used to identify test programs that correspond to or that match changed program code modules. After the test programs are identified in operation 520, they may be executed in operation 530. The purpose of performing the steps discussed in respect to FIGS. 1-5 is to identify suites of tests that provide a threshold level of test coverage such that a test process can be completed in an allocated amount of time or in a manner that uses less than a threshold number of computing resources.

FIG. 6 shows an example of computing system 600 that may be used to implement at least some of the functions reviewed in the present disclosure. In certain instances, a computing device may be incorporated into a sensing apparatus or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some instances, computing system 600 is a distributed system in which the functions described in this disclosure can be distributed within a datacenter, multiple data centers, a peer network, etc. In some instances, one or more of the described system components represents many such components each performing some or all of the function for which the component is described. In some instances, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, near, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement, and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some instances, a hardware service that performs a particular function can include the software component stored in a computer-readable medium in connection with the necessary hardware components, such as processor 610, connection 605, output device 635, etc., to carry out the function.

For clarity of explanation, in some instances, the present technology may be presented as including individual functional blocks including functional blocks comprising devices, device components, operations or routines in a method embodied in software, or combinations of hardware and software.

Any of the operations, functions, or processes described herein may be performed or implemented by a combination of hardware and software services or services, alone or in combination with other devices. In some instances, a service can be software that resides in memory of a client device and/or one or more servers of a content management system and perform one or more functions when a processor executes the software associated with the service. In some instances, a service is a program or a collection of programs that carry out a specific function. In some instances, a service can be considered a server. The memory can be a non-transitory computer-readable medium.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

FIG. 7 illustrates an example of an AV management system 700. One of ordinary skill in the art will understand that, for the AV management system 700 and any system discussed in the present disclosure, there can be additional or fewer components in similar or alternative configurations. The illustrations and examples provided in the present disclosure are for conciseness and clarity. Other instances may include different numbers and/or types of elements, but one of ordinary skill the art will appreciate that such variations do not depart from the scope of the present disclosure.

In this example, the AV management system 700 includes an AV 702, a data center 750, and a client computing device 770. The AV 702, the data center 750, and the client computing device 770 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 702 can navigate roadways without a human driver based on sensor signals generated by multiple sensor systems 704, 706, and 708. The sensor systems 704-708 can include different types of sensors and can be arranged about the AV 702. For instance, the sensor systems 704-708 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 704 can be a camera system, the sensor system 706 can be a LIDAR system, and the sensor system 708 can be a RADAR system. Other instances may include any other number and type of sensors.

The AV 702 can also include several mechanical systems that can be used to maneuver or operate the AV 702. For instance, the mechanical systems can include a vehicle propulsion system 730, a braking system 732, a steering system 734, a safety system 736, and a cabin system 738, among other systems. The vehicle propulsion system 730 can include an electric motor, an internal combustion engine, or both. The braking system 732 can include an engine brake, brake pads, actuators, and/or any other suitable componentry configured to assist in decelerating the AV 702. The steering system 734 can include suitable componentry configured to control the direction of movement of the AV 702 during navigation. The safety system 736 can include lights and signal indicators, a parking brake, airbags, and so forth. The cabin system 738 can include cabin temperature control systems, in-cabin entertainment systems, and so forth. In some instances, the AV 702 might not include human driver actuators (e.g., steering wheel, handbrake, foot brake pedal, foot accelerator pedal, turn signal lever, window wipers, etc.) for controlling the AV 702. Instead, the cabin system 738 can include one or more client interfaces (e.g., Graphical User Interfaces (GUIs), Voice User Interfaces (VUIs), etc.) for controlling certain aspects of the mechanical systems 730-738.

The AV 702 can additionally include a local computing device 710 that is in communication with the sensor systems 704-708, the mechanical systems 730-738, the data center 750, and the client computing device 770, among other systems. The local computing device 710 can include one or more processors and memory, including instructions that can be executed by the one or more processors. The instructions can make up one or more software stacks or components responsible for controlling the AV 702; communicating with the data center 750, the client computing device 770, and other systems; receiving inputs from riders, passengers, and other entities within the AV's environment; logging metrics collected by the sensor systems 704-708; and so forth. In this example, the local computing device 710 includes perception stack 712, a mapping and localization stack 714, a prediction stack 716, a planning stack 718, a communications stack 720, a control stack 722, an AV operational database 724, and an HD geospatial database 726, among other stacks and systems.

The perception stack 712 can enable the AV 702 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 704-708, the mapping and localization stack 714, the HD geospatial database 726, other components of the AV, and other data sources (e.g., the data center 750, the client computing device 770, third party data sources, etc.). The perception stack 712 can detect and classify objects and determine their current locations, speeds, directions, and the like. In addition, the perception stack 712 can determine the free space around the AV 702 (e.g., to maintain a safe distance from other objects, change lanes, park the AV, etc.). The perception stack 712 can also identify environmental uncertainties, such as where to look for moving objects, flag areas that may be obscured or blocked from view, and so forth. In some instances, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 714 can determine the AV's position and orientation (pose) using different methods from multiple systems (e.g., GPS, IMUs, cameras, LIDAR, RADAR, ultrasonic sensors, the HD geospatial database 726, etc.). For example, in some instances, the AV 702 can compare sensor data captured in real-time by the sensor systems 704-708 to data in the HD geospatial database 726 to determine its precise (e.g., accurate to the order of a few centimeters or less) position and orientation. The AV 702 can focus its search based on sensor data from one or more first sensor systems (e.g., GPS) by matching sensor data from one or more second sensor systems (e.g., LIDAR). If the mapping and localization information from one system is unavailable, the AV 702 can use mapping and localization information from a redundant system and/or from remote data sources.

The prediction stack 716 can receive information from the localization stack 714 and objects identified by the perception stack 712 and predict a future path for the objects. In some instances, the prediction stack 716 can output several likely paths that an object is predicted to take along with a probability associated with each path. For each predicted path, the prediction stack 716 can also output a range of points along the path corresponding to a predicted location of the object along the path at future time intervals along with an expected error value for each of the points that indicates a probabilistic deviation from that point.

The planning stack 718 can determine how to maneuver or operate the AV 702 safely and efficiently in its environment. For example, the planning stack 718 can receive the location, speed, and direction of the AV 702, geospatial data, data regarding objects sharing the road with the AV 702 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 702 from one point to another and outputs from the perception stack 712, localization stack 714, and prediction stack 716. The planning stack 718 can determine multiple sets of one or more mechanical operations that the AV 702 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 718 can select from multiple backup plans to carry out. For example, while preparing to change lanes to turn right at an intersection, another vehicle may aggressively cut into the destination lane, making the lane change unsafe. The planning stack 718 could have already determined an alternative plan for such an event. Upon its occurrence, it could help direct the AV 702 to go around the block instead of blocking a current lane while waiting for an opening to change lanes.

The control stack 722 can manage the operation of the vehicle propulsion system 730, the braking system 732, the steering system 734, the safety system 736, and the cabin system 738. The control stack 722 can receive sensor signals from the sensor systems 704-708 as well as communicate with other stacks or components of the local computing device 710 or a remote system (e.g., the data center 750) to effectuate operation of the AV 702. For example, the control stack 722 can implement the final path or actions from the multiple paths or actions provided by the planning stack 718. This can involve turning the routes and decisions from the planning stack 718 into commands for the actuators that control the AV's steering, throttle, brake, and drive unit.

The communications stack 720 can transmit and receive signals between the various stacks and other components of the AV 702 and between the AV 702, the data center 750, the client computing device 770, and other remote systems. The communications stack 720 can enable the local computing device 710 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 720 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 726 can store HD maps and related data of the streets upon which the AV 702 travels. In some instances, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 724 can store raw AV data generated by the sensor systems 704-708, stacks 712-722, and other components of the AV 702 and/or data received by the AV 702 from remote systems (e.g., the data center 750, the client computing device 770, etc.). In some instances, the raw AV data can include HD LIDAR point cloud data, image data, RADAR data, GPS data, and other sensor data that the data center 750 can use for creating or updating AV geospatial data or for creating simulations of situations encountered by AV 702 for future testing or training of various machine learning algorithms that are incorporated in the local computing device 710.

The data center 750 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 750 can include one or more computing devices remote to the local computing device 710 for managing a fleet of AVs and AV-related services. For example, in addition to managing the AV 702, the data center 750 may also support a ridesharing service, a delivery service, a remote/roadside assistance service, street services (e.g., street mapping, street patrol, street cleaning, street metering, parking reservation, etc.), and the like.

The data center 750 can send and receive various signals to and from the AV 702 and the client computing device 770. These signals can include sensor data captured by the sensor systems 704-708, roadside assistance requests, software updates, ridesharing pick-up and drop-off instructions, and so forth. In this example, the data center 750 includes a data management platform 752, an Artificial Intelligence/Machine Learning (AI/ML) platform 754, a simulation platform 756, a remote assistance platform 758, and a ridesharing platform 760, and a map management platform 762, among other systems.

The data management platform 752 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 750 can access data stored by the data management platform 752 to provide their respective services.

The AI/ML platform 754 can provide the infrastructure for training and evaluating machine learning algorithms for operating the AV 702, the simulation platform 756, the remote assistance platform 758, the ridesharing platform 760, the map management platform 762, and other platforms and systems. Using the AI/ML platform 754, data scientists can prepare data sets from the data management platform 752; select, design, and train machine learning models; evaluate, refine, and deploy the models; maintain, monitor, and retrain the models; and so on.

The simulation platform 756 can enable testing and validation of the algorithms, machine learning models, neural networks, and other development efforts for the AV 702, the remote assistance platform 758, the ridesharing platform 760, the map management platform 762, and other platforms and systems. The simulation platform 756 can replicate a variety of driving environments and/or reproduce real-world scenarios from data captured by the AV 702, including rendering geospatial information and road infrastructure (e.g., streets, lanes, crosswalks, traffic lights, stop signs, etc.) obtained from a cartography platform (e.g., map management platform 762); modeling the behavior of other vehicles, bicycles, pedestrians, and other dynamic elements; simulating inclement weather conditions, different traffic scenarios; and so on.

The remote assistance platform 758 can generate and transmit instructions regarding the operation of the AV 702. For example, in response to an output of the AI/ML platform 754 or other system of the data center 750, the remote assistance platform 758 can prepare instructions for one or more stacks or other components of the AV 702.

The ridesharing platform 760 can interact with a customer of a ridesharing service via a ridesharing application 772 executing on the client computing device 770. The client computing device 770 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 772. The client computing device 770 can be a customer's mobile computing device or a computing device integrated with the AV 702 (e.g., the local computing device 710). The ridesharing platform 760 can receive requests to pick up or drop off from the ridesharing application 772 and dispatch the AV 702 for the trip.

Map management platform 762 can provide a set of tools for the manipulation and management of geographic and spatial (geospatial) and related attribute data. The data management platform 752 can receive LIDAR point cloud data, image data (e.g., still image, video, etc.), RADAR data, GPS data, and other sensor data (e.g., raw data) from one or more AVs 702, Unmanned Aerial Vehicles (UAVs), satellites, third-party mapping services, and other sources of geospatially referenced data. The raw data can be processed, and map management platform 762 can render base representations (e.g., tiles (2D), bounding volumes (3D), etc.) of the AV geospatial data to enable users to view, query, label, edit, and otherwise interact with the data. Map management platform 762 can manage workflows and tasks for operating on the AV geospatial data. Map management platform 762 can control access to the AV geospatial data, including granting or limiting access to the AV geospatial data based on user-based, role-based, group-based, task-based, and other attribute-based access control mechanisms. Map management platform 762 can provide version control for the AV geospatial data, such as to track specific changes that (human or machine) map editors have made to the data and to revert changes when necessary. Map management platform 762 can administer release management of the AV geospatial data, including distributing suitable iterations of the data to different users, computing devices, AVs, and other consumers of HD maps. Map management platform 762 can provide analytics regarding the AV geospatial data and related data, such as to generate insights relating to the throughput and quality of mapping tasks.

In some instances, the map viewing services of map management platform 762 can be modularized and deployed as part of one or more of the platforms and systems of the data center 750. For example, the AI/ML platform 754 may incorporate the map viewing services for visualizing the effectiveness of various object detection or object classification models, the simulation platform 756 may incorporate the map viewing services for recreating and visualizing certain driving scenarios, the remote assistance platform 758 may incorporate the map viewing services for replaying traffic incidents to facilitate and coordinate aid, the ridesharing platform 760 may incorporate the map viewing services into the client ride sharing application 772 to enable passengers to view the AV 702 in transit en route to a pick-up or drop-off location, and so on.

Aspects of the present disclosure may include methods, methods implemented as a non-transitory computer-readable storage media, and apparatus the perform functions consistent with the present disclosure. A method of the present disclosure may include extracting features associated with a set of test programs, tagging each respective test program of the set of test programs with tags that correspond to the extracted features, and identifying a set of features associated with an update set of autonomous vehicle (AV) program code. This method may also include identifying that the tags of the respective test programs match one or more of the features of the set of features associated with the updated set of AV program code, and authorizing execution of the respective test programs based on the tags of the respective test programs matching the one or more features.

When methods of the present disclosure are implemented as a non-transitory computer-related storage media, a processor may execute instructions out of a memory. Such methods may also include extracting features associated with a set of test programs, tagging each respective test program of the set of test programs with tags that correspond to the extracted features, and identifying a set of features associated with an update set of AV program code. Here again, this method may also include identifying that the tags of the respective test programs match one or more of the features of the set of features associated with the updated set of AV program code, and authorizing execution of the respective test programs based on the tags of the respective test programs matching the one or more features.

An apparatus consistent with the present disclosure may include a processor that executes instructions out of the memory to perform a method that includes the operations of extracting features associated with a set of test programs, tagging each respective test program of the set of test programs with tags that correspond to the extracted features, and identifying a set of features associated with an update set of AV program code. Here again, the method may also include identifying that the tags of the respective test programs match one or more of the features of the set of features associated with the updated set of AV program code, and authorizing execution of the respective test programs based on the tags of the respective test programs matching the one or more features.

What is claimed is:

1. An apparatus comprising:
at least one memory; and
at least one processor coupled to the at least one memory, the at least one processor configured to:
extract a first set of features associated with a first set of test programs;
associate each respective test program of the first set of test programs with one or more tags that correspond to the extracted first set of features;
identify a second set of features associated with an updated set of autonomous vehicle (AV) program code;
determine if the one or more tags match one or more features of the second set of features associated with the updated set of AV program code; and
execute the respective test programs based on the one or more tags if the respective test programs match the one or more features of the second set of features.

2. The apparatus of claim 1, wherein the at least one processor is further configured to:
determine a test coverage for the updated set of AV program code.

3. The apparatus of claim 2, wherein the at least one processor is further configured to:
identify a first topic that corresponds to a feature of the one or more features;
identify a second set of test programs associated with the first topic based on the correspondence of the first topic to the feature; and
update the test coverage for the updated set of AV program code based on execution of the second set of test programs.

4. The apparatus of claim 1, wherein the at least one processor is further configured to:
receive a first set of test coverage data associated with the respective test programs; and
store test code database data that maps the first set of test coverage data to a first grouping of instructions of the set of AV program code.

5. The apparatus of claim 4, wherein the at least one processor is further configured to:
receive a second set of test coverage data associated a second set of test programs; and
store additional test code database data that maps the second set of test coverage data with a second grouping of instructions of the set of AV program code.

6. The apparatus of claim 5, wherein the respective test programs are executed while an observation program collects test coverage metrics, and the second set of tests are executed while the observation program continues to collect the test coverage metrics.

7. The apparatus of claim 6, wherein the test coverage metrics correspond to a number of instructions executed, a number of code paths traced, a number of program code subroutines executed, or a combination thereof.

8. A non-transitory computer-readable storage medium comprising at least one instruction for causing a computer or processor to:
extract a first set of features associated with a first set of test programs;
associate each respective test program of the first set of test programs with one or more tags that correspond to the extracted first set of features;
identify a second set of features associated with an updated set of autonomous vehicle (AV) program code;
determine if the one or more tags match one or more features of the second set of features associated with the updated set of AV program code; and
execute the respective test programs based on the one or more tags if the respective test programs match the one or more features of the second set of features.

9. The non-transitory computer-readable storage medium of claim 8, wherein the at least one instruction is further configured to cause the computer or processor to:
determine a test coverage for the updated set of AV program code.

10. The non-transitory computer-readable storage medium of claim 9, wherein the at least one instruction is further configured to cause the computer or processor to:
identify a first topic that corresponds to a feature of the one or more features;
identify a second set of test programs associated with the first topic based on the correspondence of the first topic to the feature; and
update the test coverage for the updated set of AV program code based on execution of the second set of test programs.

11. The non-transitory computer-readable storage medium of claim 8, wherein the at least one instruction is further configured to cause the computer or processor to:
receive a first set of test coverage data associated with the respective test programs; and
store test code database data that maps the first set of test coverage data to a first grouping of instructions of the set of AV program code.

12. The non-transitory computer-readable storage medium of claim 11, wherein the at least one instruction is further configured to cause the computer or processor to:
receive a second set of test coverage data associated a second set of test programs; and
store additional test code database data that maps the second set of test coverage data with a second grouping of instructions of the set of AV program code.

13. The non-transitory computer-readable storage medium of claim 12, wherein the respective test programs are executed while an observation program collects test coverage metrics, and the second set of tests are executed while the observation program continues to collect the test coverage metrics.

14. The non-transitory computer-readable storage medium of claim 13, wherein the test coverage metrics correspond to a number of instructions executed, a number of code paths traced, a number of program code subroutines executed, or a combination thereof.

15. A computer-implemented method comprising:
extracting, by a processor that executes instructions out of a memory, a first set of features associated with a first set of test programs;
tagging each respective test program of the first set of test programs with one or more tags that correspond to the extracted first set of features;
identifying, by the processor, a second set of features associated with an updated set of autonomous vehicle (AV) program code;
determining, by the processor, if the tags of the respective test programs match one or more features of the second set of features associated with the updated set of AV program code; and
executing the respective test programs based on the tags if the respective test programs match the one or more features of the second set of features.

16. The computer-implemented method of claim 15, further comprising:
determining a test coverage for the updated set of AV program code.

17. The computer-implemented method of claim 16, further comprising:
identifying a first topic that corresponds to a feature of the one or more features;
identifying a second set of test programs associated with the first topic based on the correspondence of the first topic to the feature; and
updating the test coverage for the updated set of AV program code based on execution of the second set of test programs.

18. The computer-implemented method of claim 15, further comprising:
receiving a first set of test coverage data associated with the respective test programs; and
storing test code database data that maps the first set of test coverage data to a first grouping of instructions of the set of AV program code.

19. The computer-implemented method of claim 18, further comprising:
receiving a second set of test coverage data associated a second set of test programs; and
storing additional test code database data that maps the second set of test coverage data with a second grouping of instructions of the set of AV program code.

20. The computer-implemented method of claim 19, wherein the respective test programs are executed while an observation program collects test coverage metrics, and the second set of tests are executed while the observation program continues to collect the test coverage metrics.
